(19) United States
(12) Patent Application Publication
(10) Pub. No.: US 2012/0130912 A1
(43) Pub. Date: May 24, 2012

(54) METHOD FOR PROVIDING CUSTOM INTERIOR DESIGN

(76) Inventor: Peter Marlowe, New York, NY (US)

(21) Appl. No.: 13/295,081

(22) Filed: Nov. 13, 2011

Related U.S. Application Data
(60) Provisional application No. 61/414,984, filed on Nov. 18, 2010.

(51) Int. Cl. G06Q 50/16

(52) U.S. Cl. 705/313

(57) ABSTRACT

The invention is a step-by-step method for gathering information, including but not limited to measurements. The information is used to create images for custom interior design.

This patent claims the benefit of Provisional Patent Application No. 6141984, filed on Nov. 18, 2010, a method for providing custom interior design.

### FIELD OF THE INVENTION

The present invention is a unique method of displaying the expected results to customers of proposed projects within the field of custom interior decorating and design. This application claims the benefit of the previously filed provisional application.

### BACKGROUND OF THE INVENTION

Interior decorating professionals have long been used to decorate houses, apartments and commercial spaces. However, there are very few means available to show customers the final product they hire their decorators to accomplish. This method will allow customers to view the final results of any proposed decorating scheme as well as provide price estimates for the proposed jobs.

### SUMMARY OF THE INVENTION

Generally, the present invention is a method to be utilized for interior design. More specifically, the present invention is a method for generating an accurate model of a fully designed living space, water craft, aircraft, or automobile. This invention allows an interior designer to maximize efficiency by taking steps to ensure fulfillment of the customer's needs by generating a visual model for the customer to approve before taking any actual steps in construction and remodeling. This invention will save both time and money for customers and interior designers alike. It would also reduce the margin for error in any given project and prevent miscommunication between the customer and the decorator regarding the expected outcome of the project. The method may be used in the fields comprising apartments, hotels, condos, commercial office buildings, yachts, cruise ships, aircrafts, and automobiles.

A more detailed explanation of the features, functions and advantages of the present invention is outlined in the following description.

### BRIEF DESCRIPTION OF THE DRAWINGS

For a fuller understanding of the present invention, reference is made to the following description taken in connection with the accompanying drawings:

FIG. 1 is an example of a building and the floor plan of an apartment in the aforementioned building.

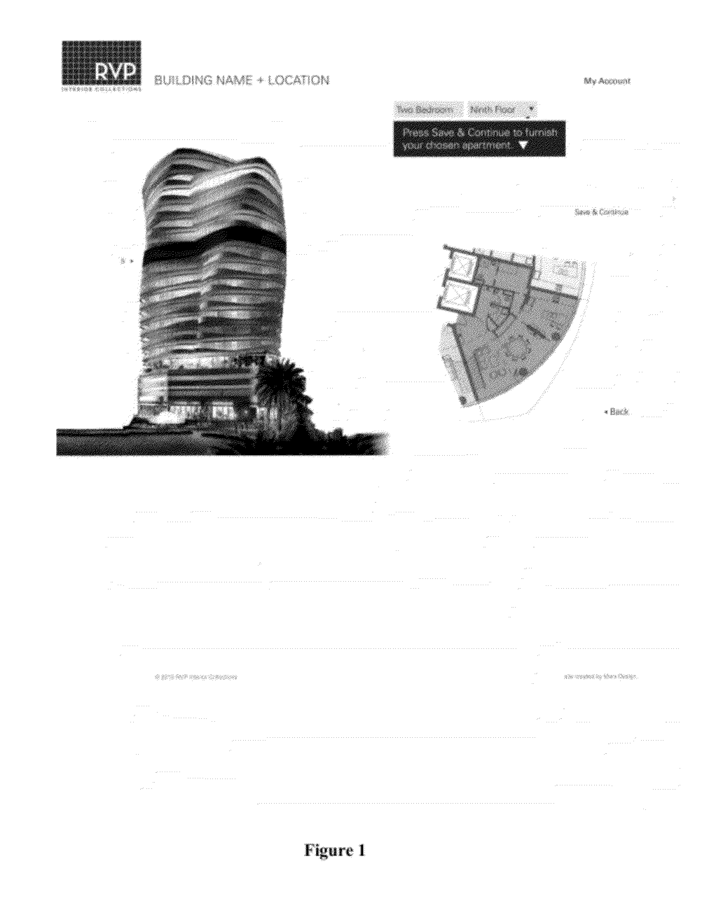

FIG. 2 is an example of customer packages available for the building referenced in FIG. 1.

FIG. 3 is the bedroom of an apartment in the building referenced in FIG. 1 highlighting an example of a furniture package.

FIG. 4 is the living room of an apartment in the building referenced in FIG. 1 highlighting the audio-visual and technology features.

FIG. 5 is the living room of an apartment in the building referenced in FIG. 1 highlighting the automation features.

### DETAILED DESCRIPTION

Reference will now be made in detail to the preferred embodiment of the present invention, examples of which are illustrated in the accompanying drawings. The preferred embodiment in no way limits the claims.

### Step One

Identify target real estate development projects. Primary targets include iconic, high end, luxury real estate projects in the planning or pre-construction phase. Projects must be no less than three (3) months from completion of construction is complete. Secondary targets include iconic high end, real estate development projects which are three (3) months or nearer to completion of construction. Construction is completed and initial individual residence closings have begun. Other potential targets include ongoing projects investigating alternative strategies to implement.

### Step Two

Select projects and sign contracts of exclusivity with developer team for interior design services and online virtual marketing tool.

### Step Three

Acquire all floor plans (including all dimensions and measurements) for all residences be included in the real estate project from the developer and/or developer's architect.

### Step Four

Acquire all relevant information and visual images pertaining to target real estate development project from the developer and/or developer's architect.

### Step Five

Identify interior designers, web site developer, artist renderers, audio-visual and technology specialists and automation specialists.

### Step Six

Select and execute subcontractor agreements with interior designers, web site developer, artist renderers, audio-visual and technology specialists, automation specialists.

### Step Seven

Provide the information gathered in Steps 3 and 4 to the interior designers, web site developer, artist renderers, audio-visual and technology specialists, automation specialists selected in Step Six.

### Step Eight

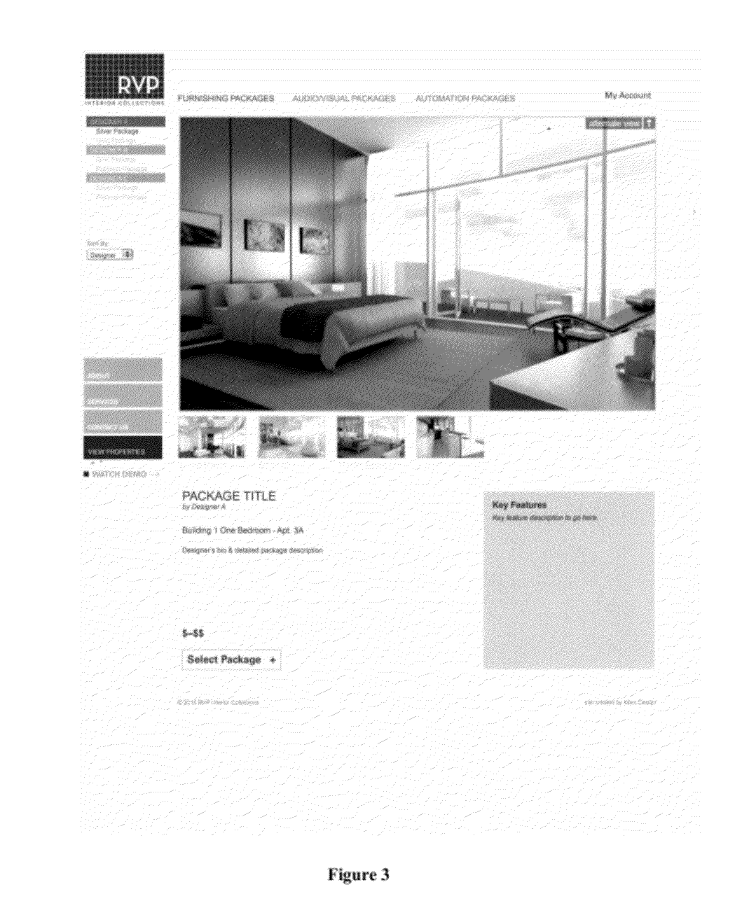

Instruct the interior designers to create furniture packages for each of the residences available in the real estate development project. They will use the measurements and layouts of floor plans to communicate with other subcontractors to achieve the optimum layout possible for the furniture packages in relation to the other packages created by the other subcontractors. This will be done for each of the rooms within the residences and for all residences within the overall real estate project. The furniture packages include, but are not limited to, all items required to fully furnish the interior of a residence and any exterior portions of a specific residence (e.g. patio, balcony, pool and BBQ area, etc), but may exclude audio-visual and technology products, and home automation products. The furniture packages will be completed as CAD drawings, sketching, or other visual medium to produce the images required. See FIG. 3.

### Step Nine

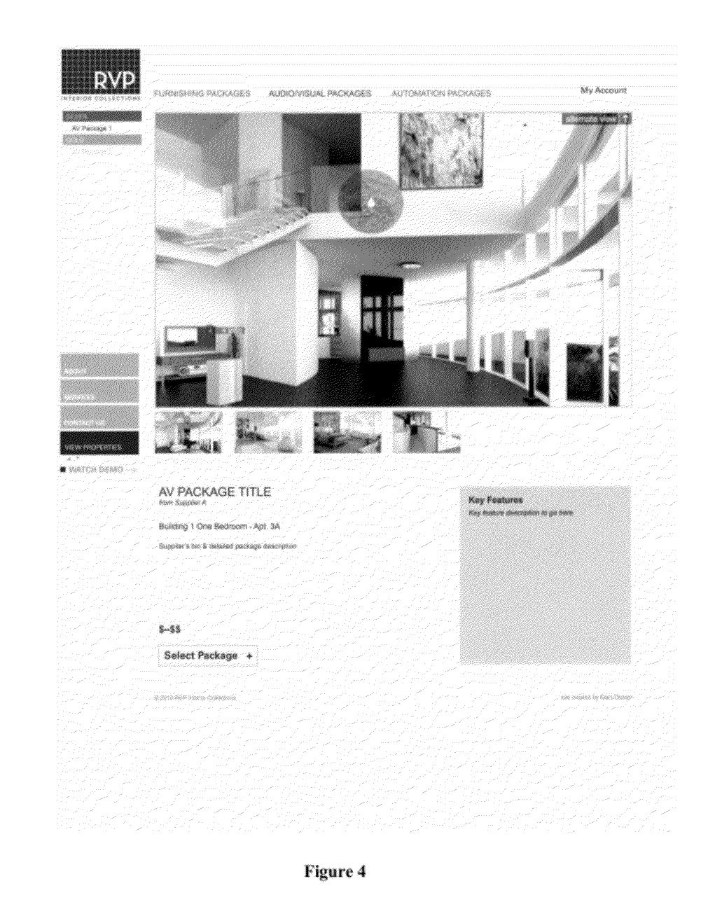

Instruct the Audio-Visual and technology specialists to create A/V and Technology packages for each of the residences available in the real estate development project. They will use the measurements and layouts of the floor plans, and communicate with other subcontractors to achieve the optimum layout possible for the A/V and Technology packages in relation to the other packages created by the other subcontractors. This will be done for each of the rooms within the residences and for all residences within the overall real estate project. The A/V and Technology packages include, but are not limited to, all technology items required for each of rooms within the residence; for all residences in the project. The A/V and Technology packages will be completed as CAD drawings, sketching, or other visual medium to produce the images required. See FIG. 4.

### Step Ten

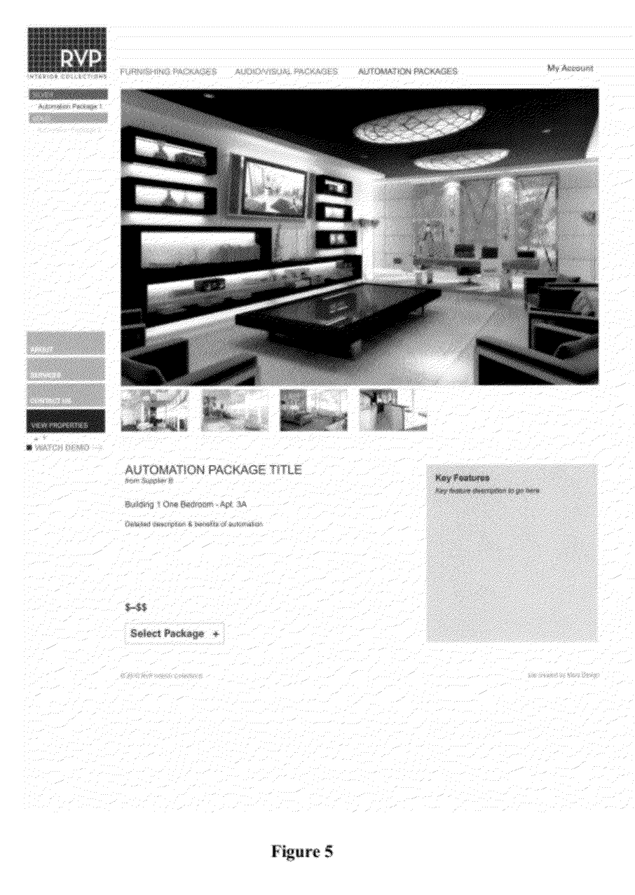

Instruct the home automation specialists to create Automation packages for each of the residences available in the real estate development project. They will use the measurements and layouts of the floor plans and communicate with other subcontractors to achieve the optimum layout possible for the Automation packages in relation to the other packages created by the other subcontractors. This will be done for each of the rooms within the residences and for all residences within the overall real estate project. The Automation packages include, but are not limited to, all technology items required to automate each of rooms within the residence for all residences in the project, and may include integrating all elements of the entire real estate development project. The Automation packages will be completed as CAD drawings, sketching, or other visual medium to produce the images required. See FIG. 5.

### Step Eleven

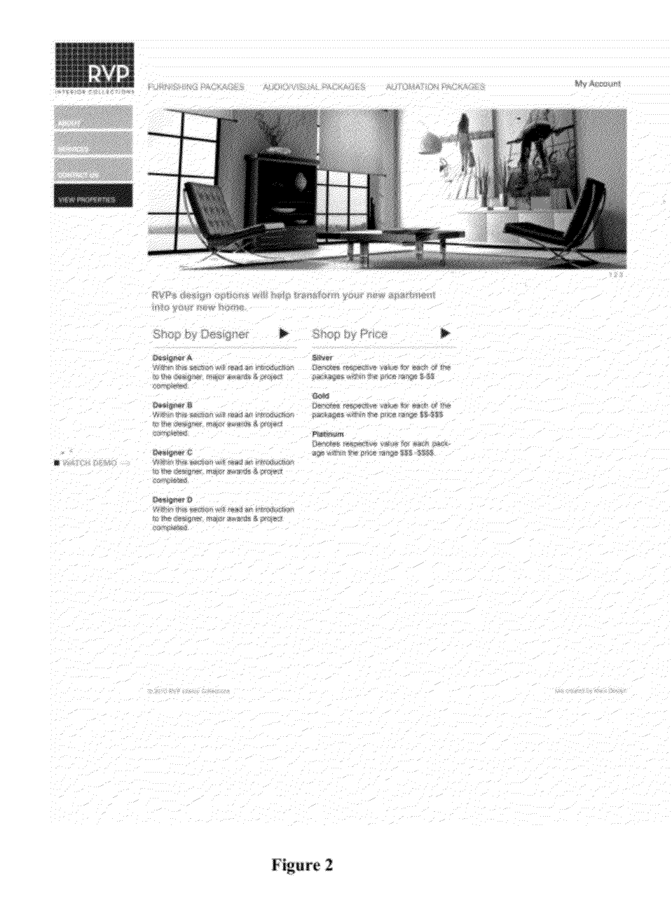

Instruct the Interior Designers, Audio-Visual and Technology Specialists and Home Automation Specialists to establish price ranges for each of the packages created. For the preferred embodiment only, 3 price ranges will be established: 1) Entry Level (Silver Package) 2) Mid Tier (Gold Package) 3) High End (Platinum Package). Each of the packages, regardless of the price range will be able to be mixed-and-matched to provide greater flexibility and accessibility. For example, a customer could purchase a Silver Furnishing Package and combine it with the Gold Audio-Visual and Technology Package, and the Platinum Home Automation Package. The customer is able to select packages by style, designer or budget (represented by precious metal label). See FIG. 2.

### Step Twelve

When Interior Designers, A/V and Tech Specialists, and Home Auto Specialists have completed creating their respective packages, all information pertaining to the package and images of packages will be provided to the artist renderers and the web site developer.

### Step Thirteen

Instruct artist renderers to render all images of items/products contained within the furnishing packages, A-V and technology packages, and Home Automation packages into the 3-dimensional viewing platform to create a virtual, fully furnished residence. Rendered images are completed to a photographic, life-like quality. Repeat this step for each of the residences available in the real estate project.

### Step Fourteen

Upon completion of Step 13, provide web site developer with all files completed by the artist renderer in step 13.

### Step Fifteen

Instruct the website developer to transplant the information provided in Step Fourteen into the dedicated web site on the relevant web pages.

What is claimed is:

1. A business method comprising:
identifying real estate development project(s);
executing contract(s) with the development project for interior design services;
acquiring blue prints for development project;
acquiring visual images for development project;
identifying subcontractors;
executing contracts with subcontractors;
instructing subcontractors to create packages based upon cost;
instructing subcontractor to render images comprising blue prints, visual images, and items contained in the packages, into a viewing platform;
instructing subcontractor to create a web page using the viewing platform.

2. The method described in claim 1 wherein said development project is/are automobile(s).

3. The method described in claim 1 wherein said development project is/are yacht(s).
